(19) United States
(12) Patent Application Publication
(10) Pub. No.: US 2007/0183803 A1
(43) Pub. Date: Aug. 9, 2007

(54) IMAGE FORMING APPARATUS HAVING AN IMPROVED DUPLEX PRINTING ABILITY

(75) Inventor: Byoung-chul BAE, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/670,206

(22) Filed: Feb. 1, 2007

(30) Foreign Application Priority Data
Feb. 3, 2006 (KR) 2006-10816

(51) Int. Cl. G03G 15/16

(52) U.S. Cl. 399/66

(57) ABSTRACT

An image forming apparatus which measures resistance of a recording medium on which an image formed and applies a transfer voltage corresponding to this resistance to the recording medium, thereby improving a duplex printing quality.

### CROSS-REFERENCE TO RELATED APPLICATION

This application claims the benefit of Korean Patent Application No. 2006-10816, filed Feb. 3, 2006 in the Korean Intellectual Property Office, the disclosure of which is incorporated herein by reference.

### BACKGROUND OF THE INVENTION

1. Field of the Invention

An aspect of the present invention relates to an image forming apparatus, and, more particularly, to an image forming apparatus having a duplex printing function.

2. Description of the Related Art

In general, an image forming apparatus is connected to a host apparatus to print image data that is generated or stored in the host apparatus according to an output signal applied from the host apparatus on a recording medium. An electrophotography type of image forming apparatus has a photosensitive body on which an electrostatic latent image is formed, a developing unit to develop developer on the photosensitive body, and a transferring device to transfer the developer developed on the photosensitive body on a recording medium (i.e., printing paper).

An electrophotographic image forming apparatus comprises a printer, a photocopier, and a multi-functional device. These image forming apparatuses comprise a variety of additional functions to satisfy demands of users. In particular, duplex printing technology to simultaneously form images on both sides of the recording medium has been developed.

FIG. 1 is a schematic view illustrating a configuration of a conventional image forming apparatus 1 including a duplex printing. As shown in FIG. 1, the image forming apparatus 1 has a feeding part 10 in which recording media are stored. An image forming part 20 forms an image on the recording medium fed from the feeding part 10. A fixing part 30 fixes developer on the surface of the recording medium by an application of heat and pressure. A direction changing part 40 changes a feeding direction of the recording medium having passed through the fixing part 30. A duplex printing part 50 turns the recording medium over to enable the recording medium to re-enter the image forming part 20 to change a printing side of the recording medium, A discharging part 60 discharges the recording medium on which an image is formed from the image forming apparatus 1.

In the conventional duplex printing process of the image forming apparatus 1, a resistance of a recording medium fed from the feeding part 10 is measured and a transfer voltage corresponding to the resistance is applied by the transfer unit 25 to transfer the developer on the photosensitive body 23 onto a first side of the recording medium. Then, the fixing part 30 applies the heat and pressure to the recording medium to fix the developer on the first side of the recording medium. Next, a feeding direction of the recording medium, on which the developer is spread on one side, is changed in the direction changing part 40 to cause the recording medium to re-enter the image forming part 20 through the duplex printing part 50. Then, the transfer unit 25 applies a transfer voltage and spreads developer on the second side of the recording medium.

Here, in the conventional image forming apparatus 1, after the transfer unit 25 measures the resistance of the recording medium, the transfer unit 25 transfers the developer onto the first side of the recording medium with the first transfer voltage corresponding to this resistance. Then, the transfer unit 25 applies a second transfer voltage corresponding to the firstly measured resistance on the second side of the recording medium that has re-entered the image forming apparatus 1 through the duplex printing part 50 to form an image on the second side of the recording medium. That is, the first transfer voltage and the second transfer voltage are determined according to the first measured resistance of the recording medium.

When an image is formed by the first transfer voltage on the recording medium, moisture is removed from the recording medium as a result of the application of the heat and pressure on the recording medium in the fixing part. Thus, static electricity is generated with respect to the recording medium during the transferring process, and the recording medium, temporarily, has a resistance that is four or five times as large as what the resistance would be if an image were not formed thereon.

However, in the conventional image forming apparatus 1, as described above, when an image is formed on the second side of the recording medium, the second transfer voltage, which is uniformly set according to the first resistance without considering a sudden change in the resistance of the recording medium, is applied to the recording medium to form an image on the second side thereof. As a result, there is a problem that the printing quality of the duplex printed recording medium is depreciated. For example, in the case in which a second transfer voltage that is larger than a transfer voltage corresponding to the resistance of the recording medium, on the first side of which an image is formed is applied, there may be a problem that the developer spread on the recording medium from a photosensitive body is re-spread on the photosensitive body or the developer line bursts on the recording medium.

### SUMMARY OF THE INVENTION

Aspects of the invention provide an image forming apparatus which measures resistance of a recording medium on which an image formed and applies a transfer voltage corresponding to this resistance, thereby improving a duplex printing quality.

According to an aspect of the present invention, an image forming apparatus including a photosensitive body on which developer is spread and a transfer unit which supplies a transfer voltage on a recording medium, and forming an image on both sides of the recording medium, comprising: a fixing part to apply heat and pressure to the recording medium and to fix developer on the recording medium; a first resistance measuring part which is provided in the transfer unit and which measures a first resistance of the recording medium; a second resistance measuring part which is provided in the fixing part and which measures a second resistance of the recording medium on the first side of which an image is formed; and a controller to control the transfer unit and the fixing part to supply a first transfer voltage corresponding to the first resistance measured in the first resistance measuring part and form an image on the first side of the recording medium, and to supply a second transfer voltage corresponding to the second resistance measured in the second resistance measuring part and form an image on a second side of the recording medium.

According to another aspect of the present invention, an image forming apparatus further comprises a storing part in which a transfer voltage list corresponding to the resistances of the recording medium is stored.

According to another aspect of the present invention, the fixing part comprises a heating roller to heat the recording medium, and a pressing roller to press the recording medium, and the seconding resistance measuring part is provided in one of the heating roller and the pressing roller and supplies a predetermined fusing voltage to the recording medium on the first side of which an image is formed, and measures the second resistance.

According to another aspect of the present invention, the first resistance comprises a recording medium resistance and an environment resistance with respect to the photosensitive body, and the second resistance comprises a recording medium resistance with the developer being spread on the first side and a static electricity generated on the recording medium after the first transfer voltage is supplied.

According to an aspect of the present invention, an image forming method to form an image on both sides of a recording medium, comprises: measuring a first resistance of the recording medium, supplying a first transfer voltage corresponding to the first resistance, and spreading developer on a first side of the recording medium to form an image; measuring a second resistance of the recording medium on which the developer is spread, and applying heat and pressure to the recording medium to fix the developer on a first side of the recording medium; and supplying a second transfer voltage corresponding to the second resistance and spreading the developer on the second side of the recording medium to form the image.

According to another aspect of the present invention, an image forming method further comprises selecting a first transfer voltage and a second transfer voltage corresponding to the first resistance and the second resistance from a predetermined transfer voltage list after measuring the first resistance and the second resistance of the recording medium.

According to an aspect of the present invention, an image forming method of an image forming apparatus having a photosensitive body on which developer is spread and a transfer unit which transfers the developer from the photosensitive body to the recording medium by applying a transfer voltage, and a fixing unit which fixes the developer on the recording medium, the method comprises: measuring a first resistance of the recording medium, supplying the first transfer voltage corresponding to the first resistance, and spreading the developer from the photosensitive body on a first side of the recording medium; measuring a second resistance of the recording medium having the first side onto which the developer is transferred, and fixing the developer on the first side of the recording medium; and supplying a second transfer voltage corresponding to the second resistance, and transferring the developer on a second side of the recording medium.

According to another aspect of the present invention, the transfer unit measures the first resistance of the recording medium.

According to another aspect of the present invention, the transfer unit measures the second resistance of the recording medium having the first side onto which the developer is transferred.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view schematically illustrating a configuration of a conventional image forming apparatus for duplex printing.

FIGS. 2A and 2B are schematic views illustrating a configuration of an image forming apparatus according to an aspect of the present invention.

FIG. 3 is a flow diagram illustrating an operating process of an image forming apparatus according to the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

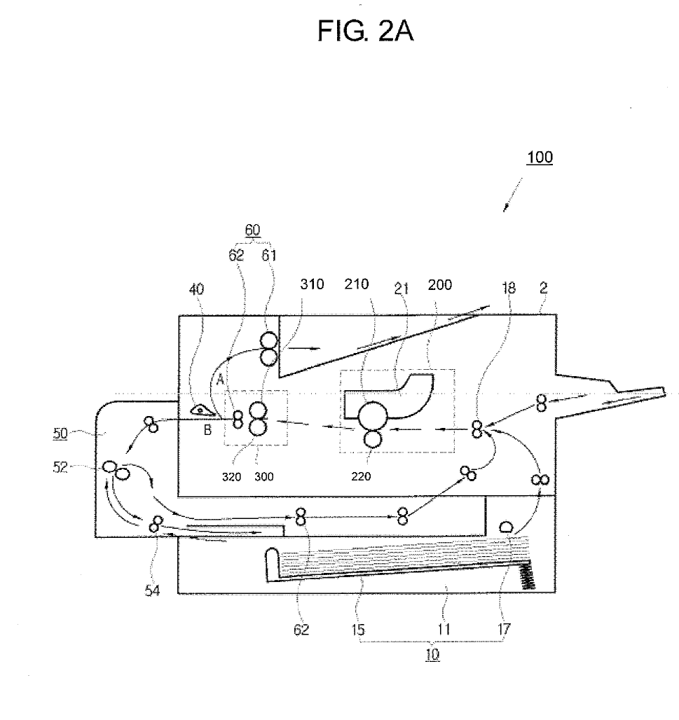

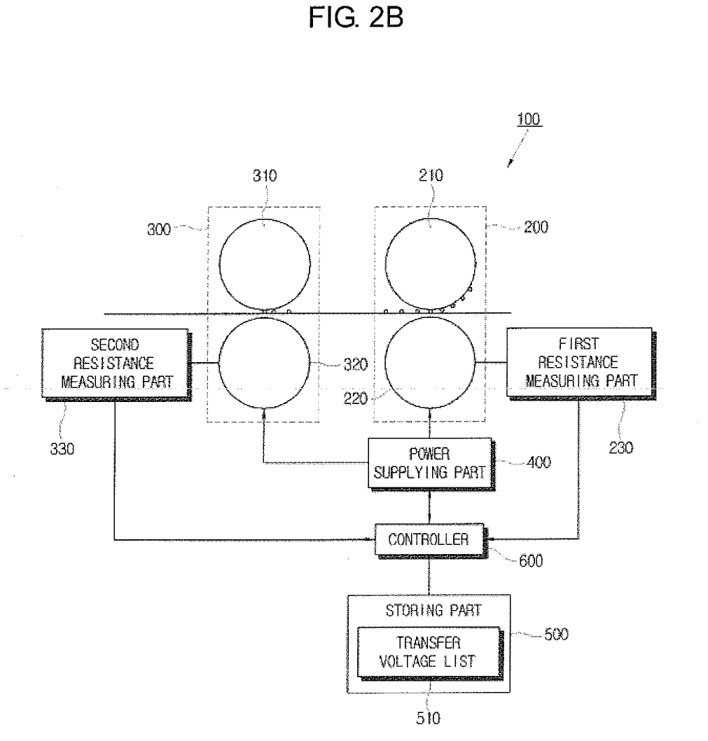

FIGS. 2A and 2B are schematic views illustrating a configuration of an image forming apparatus 100 according to an embodiment of the present invention. As shown in FIGS. 2A and 2B, the image forming apparatus 100 comprises a feeding part 10 to feed recording media into the image forming apparatus 100. An image forming part 200 forms an image on the recording medium fed from the feeding part 10. A first resistance measuring part 230, provided on a side of the image forming part 200, measures a first resistance of the recording medium. A fixing part 300 fixes the image formed by the image forming part 200 onto the recording medium. A second resistance measuring part 330, which is provided on a side of the fixing part 300, measures a second resistance of the recording medium on which the image is formed. A power supplying part 400 supplies the image forming part 200 and the fixing part 300 with power. A storing part 500 stores a transfer voltage list 510 having entries that correspond to resistances of the recording medium. A controller 600 controls the image forming part 200, the power supplying part 400 and the fixing part 300 to form an image on a first side of the recording medium by an application of the first transfer voltage and to form an image on the second side of the recording medium by an application of the second transfer voltage.

Further, the image forming apparatus 100 according to an embodiment of the present invention comprises a discharging part 60 to discharge the recording medium, on which an image is formed, from the image forming apparatus 100, and a duplex printing part 50 to change the feeding direction of the discharged recording medium so as to enable the recording medium to re-enter the image forming part 200.

In the operation of the feeding part 10, a pickup roller 17 provides a frictional force onto a recording medium stacked on a knock-up plate 15 so as to feed the recording medium toward the image forming part 200 when a printing signal is inputted to the image forming apparatus 100. The discharging part 60 discharges the recording medium, on which an image is fixed, to the exterior of the image forming apparatus 100. The discharging part 60 comprises a plurality of transfer units 33 and discharging rollers 61 and 62.

The duplex printing part 50 changes the transmitting route of the recording medium, which is discharged after an image is formed on its first side, to enable the recording medium to re-enter the image forming part 200. The duplex printing part 50 comprises reverse turning rollers 52 and 54 which turn the recording medium over inside a transmitting route changing part 40 so as to enable the second side of the recording medium to be printed.

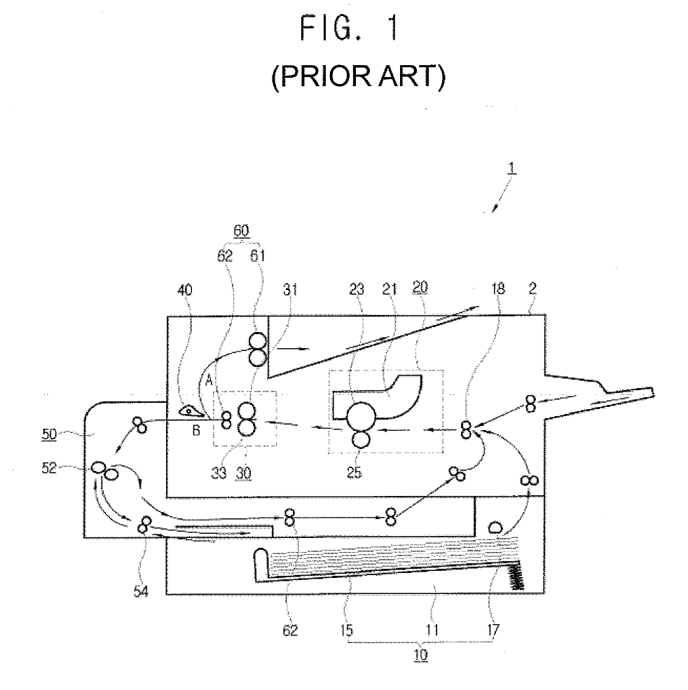

A description of the configuration of the feeding part 10, the duplex printing part 50 and the discharging part 60 will be omitted as these features have similar configurations as in the conventional apparatus shown in FIG. 1 Additionally, while shown by way of a comparison of a like apparatus in FIG. 1, it is understood that the image forming apparatus 100 can be otherwise configured, such as by having trays not having the knock up plate 15, and trays instead of or in addition to a tray having the shown knock-up plate 15 and/or the discharge area after the rollers 61.

The image forming part 200 spreads developer onto the recording medium to form an image thereupon. The image forming part 200 comprises a photosensitive body 210 to spread developer onto the recording medium. An electrifying roller (not shown) electrifies the photosensitive body 210 to a predetermined potential. A light scanning unit (not shown) scans light beams onto the photosensitive body 210. A developing roller (not shown) supplies the photosensitive body 20 with developer. A transfer unit 220 transfers the developer from the surface of the photosensitive body 210 onto the recording medium. The first resistance measuring part 230, which is provided in the transfer unit 220, measures a first resistance of the recording medium.

The first resistance measuring part 230 supplies a predetermined voltage to measure the recording medium resistance when the recording medium, fed from the feeding part 10, enters the nip defined between the photosensitive body 210 and the transfer unit 220. The resistance of the recording medium has different values according to the quality, the thickness, the kind, and the size of the recording medium. The first resistance measuring part 230, after having measured the recording medium resistance, re-supplies a predetermined voltage to measure the environment resistance between the recording medium and the photosensitive body 210. The environment resistance refers to a resistance value generated among the components inside the image forming part 200. The first resistance measuring part 230 informs a controller 600 of a first resistance including the recording medium resistance and the environment resistance.

Here, according to an embodiment of the invention, the first resistance measuring part 230 is integrated with the transfer unit 220, but may be separated therefrom.

The fixing part 300 applies heat and pressure to the recording medium, on which the developer is spread, and thereby fixes the developer on the recording medium. The fixing part 300 comprises a heating roller 310 and a pressing roller 320, which faces the heating roller 310, to press the recording medium when the recording medium is fed between the pressing roller 320 and the heating roller 310. The second resistance measuring part 330 measures a second resistance of the recording medium.

The second resistance measuring part 330 supplies a predetermined fusing voltage to the recording medium and measures the second resistance to inform the controller 600 of a result of the measurement when the recording medium, on which an image is formed in the image forming part 200, enters a space between the heating roller 310 and the pressing roller 320. The fusing voltage refers to a voltage which is supplied in advance on the recording medium to prevent the developer from line-bursting as a result of the heat of the heating roller 310 while the recording medium enters the fixing part 300 before the developer is fixed.

The second resistance measuring part 330 supplies the fusing voltage to the recording medium and measures the second resistance. Here, the second resistance takes into account a static electricity generated on the recording medium by the transfer voltage, the recording medium resistance after the developer is spread thereon, and an environment resistance with respect to the components around the recording medium.

Here, the second resistance measuring part 330 may be provided on one end side of the pressing roller 320, or the heating roller 310. According to embodiments of the invention, separation of the developer from the recording medium is to be prevented. To this end, the second resistance measuring part 330 supplies a positive fusing voltage to the recording medium where the second resistance measuring part 330 is provided on one side of the pressing roller 320, and supplies a negative fusing voltage to the recording medium where the second resistance measuring part 330 is provided on one side of the heating roller 310.

The power supplying part 400 supplies the image forming part 200 and the fixing part 300 with power according to a control signal of the controller 600.

The storing part 500 comprises a transfer voltage list 510 indicating transfer voltages of the transfer unit 220 corresponding to the resistances of the recording medium measured in the resistance measuring parts 230 and 330. The optimum transfer voltages corresponding to various recording medium resistances are provided in the transfer voltage list 510 as a table, but can be otherwise stored in the storing part 500.

In addition, image data applied from a host apparatus (not shown) is stored in the storing part 500. The image data corresponding to each one-sided or duplex printing is stored therein, and image data corresponding to a first side and a second side is respectively stored when duplex printing is performed. The storing part 500 may be provided internal or external to the apparatus as Random Access Memory (RAM), Read Only Memory (ROM), a Hard Disk Drive (HDD), flash memory, optical media, and/or combinations thereof.

The controller 600 searches for a transfer voltage that corresponds to the first resistance, which is measured in the first resistance measuring part 230, in the transfer voltage list 510 of the storing part 500. This searching allows for a selection of a first transfer voltage corresponding to the transfer voltage that corresponds to the first resistance. The controller 600 then controls the transfer unit 220 to supply the selected first transfer voltage onto the recording medium. Also, where a user inputs a duplex printing signal, the controller 600 controls the transfer unit 220 to search for the transfer voltage that corresponds to the second resistance, which is measured in the second resistance measuring part 330, and to supply the corresponding second transfer voltage onto the recording medium.

Next, the power supplying part 500 supplies the image forming part 200 and the fixing part 300 with power according to the control signal of the controller 600, and the transfer unit 220 supplies a transfer voltage corresponding to the resistance of the recording medium to form an image on the recording medium.

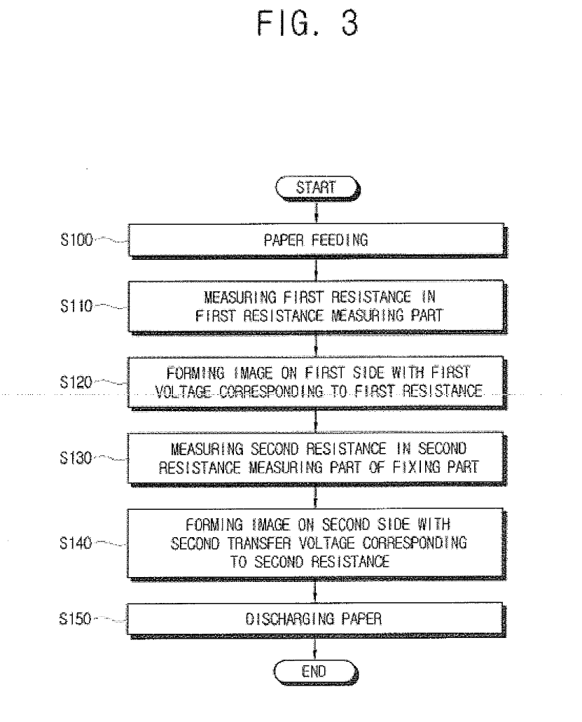

A duplex printing process of the image forming apparatus 100 with this configuration, according to an embodiment of the present invention, will be described by referring to FIGS. 2A to 3.

First, when a user inputs a duplex printing signal, the pick-up roller 17 feeds a recording medium from the knock-up plate 15 to the image forming part 200 (S100). When the recording medium, fed by the transmitting roller 18, enters between the photosensitive body 210 of the image forming part 200 and the transfer unit 220, the first resistance measuring part 230, which is provided on one side of the transfer unit 220, supplies a predetermined voltage to measure a first resistance. In addition, the first resistance measuring part 230 informs the controller 600 of the result. Here, the measured first resistance includes a recording medium resistance and an environment resistance (S110).

Meanwhile, the light scanning apparatus (not shown) of the image forming part 200 scans light beams onto the photosensitive body 210 to form an electrostatic latent image corresponding to the image data received from the host apparatus (not shown) on the surface of the photosensitive body 210. A developing roller (not shown) of the image forming part 200 is supplied with developer from the developer supplying part 21 to spread the developer on the electrostatic latent image of the photosensitive body 210.

The controller 600 searches and selects a first transfer voltage corresponding to the first resistance received from the first resistance measuring part 230 from the transfer voltage list 510 of the storing part 500, and controls the power supplying part 500 and the transfer unit 220 to supply the selected first transfer voltage onto the recording medium. The transfer unit 220 supplies the first transfer voltage on the recording medium. Then, the developer, which is spread on the electrostatic latent image of the photosensitive body 210, is transferred onto a first side of the recording medium to form an image (Sl20).

For duplex printing, when the recording medium, on the first side of which an image is formed, enters the fixing part 300, the second resistance measuring part 330 measures a second resistance of the recording medium to inform the controller 600 of the result. The second resistance includes a static electricity generated during the transferring process by the transfer unit 220, and a recording medium resistance which the recording medium has in itself. As moisture evaporates from the recording medium, on the first side of which the image is formed, during the image forming process, the recording medium has a larger recording medium resistance than the first resistance.

The second resistance measuring part 330 supplies a fusing voltage on the recording medium to measure this second resistance. The second resistance measuring part 330 then informs the controller 600 of the result. Here, the second measuring part 330 may be provided in one of the heating roller 310 and the pressing roller 320 (S130).

Meanwhile, the heating roller 310 heats the recording medium, and the pressing roller 320 presses the recording medium to fix the developer on the first side of the recording medium. The feeding direction of the recording medium is changed by the direction changing part 40 provided on the recording medium discharging route. Then, the recording medium re-enters the duplex printing part 50.

The recording medium, which re-enters the duplex printing part 50, is turned over by the reverse turning rollers 52 and 54. When the recording medium enters the photosensitive body 210 and the transfer unit 220, the controller 600 searches and selects a second transfer voltage corresponding to the second resistance that is received from the second resistance measuring part 330, and controls the transfer unit 220 and the power supplying part 400 to supply the selected second transfer voltage on the recording medium. An electrostatic latent image corresponding to image data to be formed on the second side of the recording medium is formed on the surface of the photosensitive body 210. Then, the developer on the surface of the photosensitive body is spread onto the second side of the recording medium to form an image when the transfer unit 220 supplies the second transfer voltage (S140).

When the recording medium, on the second side of which an image is formed, enters the fixing part 300, the heating roller 310 and the pressing roller 320 apply heat and pressure to the recording medium to form an image on the second side of the recording medium. The recording medium, on both sides of which images are formed, is then discharged to the outside the apparatus 100 onto a tray through the discharging part 60.

Of course, it is understood that the method of the present invention, as described above, may be embodied as a computer readable medium having a program or programs stored thereon to execute the method.

As is described above, the image forming apparatus according to aspects of the present invention respectively measures a first resistance of a recording medium on which an image is not formed, and a second resistance of the recording medium, on the first side of which an image is formed, to supply the optimum transfer voltage corresponding to each resistance to the recording medium to form an image. By this configuration, as the optimum transfer voltage corresponding to the change of a resistance generated by a recording medium characteristic and an environmental change is supplied after an image is formed on the first side of the recording medium, thereby improving a printing quality, and, more particularly, a printing quality of the second side of the recording medium.

Although a few embodiments of the present invention have been shown and described, it would be appreciated by those skilled in the art that changes may be made in this embodiment without departing from the principles and spirit of the invention, the scope of which is defined in the claims and their equivalents.

1. A transfer voltage determination apparatus to use in an image forming apparatus including a photosensitive body on which developer is spread, a transfer unit which supplies a transfer voltage on a recording medium to form an image on both sides of the recording medium, and a fixing part to apply heat and/or pressure to the recording medium so as to fix the developer on the recording medium, the transfer voltage determination apparatus comprising:
a first resistance measuring part, which is provided at the transfer unit, to measure a first resistance of the recording medium;
a second resistance measuring part, which is provided at the fixing part, to measure a second resistance of the recording medium after the transfer unit forms the image on the first side; and
a controller to control the transfer unit and the fixing part to supply to the transfer unit a first transfer voltage corresponding to the first resistance measured in the first resistance measuring part so as to form the image on the first side of the recording medium, and to supply to the transfer unit a second transfer voltage corresponding to the second resistance measured in the second resistance measuring part so as to form the image on the second side of the recording medium.

2. The transfer voltage determination apparatus according to claim 1, further comprising a storing part which stores a transfer voltage list of transfer voltages corresponding to resistances of the recording medium, wherein:
the controller, to supply the first transfer voltage, retrieves from the stored transfer voltage list one of the transfer voltages corresponding to the measured first resistance, and
the controller, to supply the second transfer voltage, retrieves from the stored transfer voltage list one of the transfer voltages corresponding to the measured second resistance.

3. The transfer voltage determination apparatus according to claim 1, wherein the fixing part comprises a heating roller to heat the recording medium, and a pressing roller to press the recording medium.

4. The transfer voltage determination apparatus according to claim 3, wherein the second resistance measuring part is provided in the heating roller and/or the pressing roller, supplies a predetermined fusing voltage to the recording medium, on the first side of which the image is formed, and measures the second resistance.

5. The transfer voltage determination apparatus according to claim 4, wherein:
the first resistance comprises a recording medium resistance and an environment resistance with respect to the photosensitive body, and
the second resistance comprises a recording medium resistance, with the developer being spread on the first side thereof, and static electricity generated on the recording medium after the first transfer voltage is supplied thereto.

6. An image forming method to form an image on both sides of a recording medium, comprising:
measuring a first resistance of the recording medium;
supplying to the recording medium a first transfer voltage corresponding to the measured first resistance;
transferring developer to a first side of the recording medium to form the image on the first side of the recording medium using the supplied first transfer voltage;
measuring a second resistance of the recording medium on which the image is formed on the first side;
applying heat and pressure to the recording medium to fix the transferred developer on the first side of the recording medium;
supplying to the recording medium a second transfer voltage corresponding to the measured second resistance and
transferring the developer to a second side of the recording medium to form the image on the second side of the recording medium using the supplied second transfer voltage.

7. The image forming method according to claim 6, further comprising selecting a first transfer voltage corresponding to the measured first resistance and a second transfer voltage corresponding to the measured second resistance from a predetermined transfer voltage list.

8. A computer readable medium having a program stored thereon to execute the method according to claim 6 performed by one or more computers.

9. An image forming method of an image forming apparatus having a photosensitive body on which developer is spread and a transfer unit which transfers the developer from the photosensitive body to a recording medium by applying a transfer voltage to the recording medium, and a fixing unit which fixes the developer on the recording medium, the method comprising:
after measuring a first resistance of the recording medium, forming an image on the recording medium by supplying a first transfer voltage corresponding to the measured first resistance to the recording medium and transferring the developer from the photosensitive body to a first side of the recording medium;
measuring a second resistance of the recording medium on which the image is formed on the first side, and fixing the developer on the first side of the recording medium to fix the image on the first side; and
forming an image on a second side of the recording medium by supplying a second transfer voltage corresponding to the measured second resistance, and transferring the developer to the second side.

10. The method according to claim 9, further comprising measuring the first resistance using the transfer unit.

11. The method according to claim 10, wherein the measuring the second resistance comprises the transfer unit measuring the second resistance of the recording medium having the first side onto which the developer is transferred.

12. A computer readable medium having a program stored thereon to execute the method according to claim 9 performed by one or more computers.

13. An image forming apparatus to perform single and/or duplex printing with respect to a recording medium, comprising:
a first resistance measuring part to measure a first resistance of the recording medium;
a transfer unit to impart to the recording medium a first transfer voltage corresponding the measured first resistance such that developer is transferred to a first side of the recording medium and, after the developer is fixed to the first side, to impart to the recording medium a second transfer voltage corresponding a measured second resistance such that developer is transferred to a second side of the recording medium; and
a second resistance measuring part to measure the second resistance of the recording medium after the developer is fixed to the first side.

14. The image forming apparatus according to claim 13, further comprising:
a storing part which stores a transfer voltage list of transfer voltages corresponding to resistances of the recording medium, and
a controller to retrieve from the stored transfer voltage list one of the transfer voltages corresponding to the measured first resistance and to control the transfer unit to impart the retrieved one transfer voltage as the first transfer voltage, and to retrieve from the stored transfer voltage list one of the transfer voltages corresponding to the measured second resistance and to control the transfer unit to impart the retrieved one transfer voltage as the second transfer voltage.

15. The image forming apparatus according to claim 13, further comprising a fixing part to fix the transferred developer to the first and second sides, the fixing part comprising:
a heating roller to heat the recording medium; and
a pressing roller to apply pressure to the recording medium.

16. The image forming apparatus according to claim 15, wherein the second resistance measuring part is provided in one of the heating roller and the pressing roller, and, to measure the second resistance, supplies a predetermined fusing voltage to the recording medium, on the first side of which the image is formed.

17. The image forming apparatus according to claim 16, wherein the first resistance comprises a recording medium resistance and an environment resistance with respect to the photosensitive body, and wherein the second resistance comprises a recording medium resistance, with the developer being spread on the first side thereof, and a static electricity generated on the recording medium after the first transfer voltage is supplied thereto.

18. An image forming method to form an image on both sides of a recording medium, comprising:
after measuring a first resistance of the recording medium, supplying to the recording medium a first transfer voltage corresponding to the measured first resistance to form the image on the first side of the recording medium;
measuring a second resistance of the recording medium; and
supplying to the recording medium a second transfer voltage corresponding to the measured second resistance to form the image on the second side of the recording medium.

19. A computer readable medium having a program stored thereon to execute the method according to claim 18 on one or more computers.

20. An image forming apparatus to perform a duplex printing operation on a recording medium in which a resistance of the recording medium is measured after a first transfer voltage is applied to the recording medium to print an image on a first side thereof.
